(19) United States
(12) Patent Application Publication
(10) Pub. No.: US 2011/0123037 A1
(43) Pub. Date: May 26, 2011

(54) SOUND MASKING SYSTEM AND METHOD USING VIBRATION EXCITER

(75) Inventor: André L'Espérance, Quebec (CA)

(73) Assignee: Soft DB Inc.

(21) Appl. No.: 12/530,912

(22) PCT Filed: May 14, 2009
(86) PCT No.: PCT/CA2009/000675

§ 371 Date: Sep. 11, 2009

Related U.S. Application Data
(60) Provisional application No. 61/076,354, filed on Jun. 27, 2008.

(51) Int. Cl. H04R 3/02

(52) U.S. Cl. 381/73.1

(57) ABSTRACT

A system and a method for generating a sound masking in a room, comprising a masking sound generator and at least one vibration exciter connected to a support in the room, and the at least one vibration exciter, driven by the masking sound generator, subjecting the support of the room to controlled and reproducible mechanical vibrations.

### FIELD OF THE INVENTION

The present invention relates to sound-masking systems and methods. More precisely, the present invention relates to a masking sound system and method using vibration exciters fixed on existing structures of an enclosure in which masking sound is required.

### BACKGROUND OF THE INVENTION

Sound-masking systems are used to enhance speech privacy and the comfort of workers in a working environment for example. The aim of a sound-masking system is to increase the background noise of a room just enough to mask any distracting noises. The distracting noises generally comprise short acoustic events containing information like a conversation, printer noises, telephones ringing, etc. . . .

As sound-masking systems were being developed, it was established that their efficiency is linked to their ability to emit an ideal masking sound spectrum with an adequate precision. The ideal masking sound has been defined to achieve optimized speech privacy at a listener's position as presented in Acoustical Design of Conventional Open Plan Offices, Institute for research & construction, National Research Council, Canadian Acoustic, vol. 27. No. 3 (2003).

Sound-masking systems generally include a masking sound generator, an equalizer, a power amplifier and one or more loudspeakers.

A number of documents are related to signal generators and their adjustment, such as, for example, U.S. Pat. No. 4,054,751 or U.S. Pat. No. 4,010,324. More recently, an automatic adjustment method has also been proposed in an application in the United States US 2006/0009969 by the present Applicants.

There are also various patents related to a loudspeaker layout and connectivity, for example U.S. Pat. No. 3,985,957 and Canadian patent application CA 1,154,689. Others patents present new loudspeaker designs, for example, U.S. Pat. No. 4,052,564 and U.S. Pat. No. 6,164,408, or patent application US2003/0219133A1.

All current commercialized sound-masking systems use loudspeakers as sound sources. In 1978, Howard Norma McGregor, in U.S. Pat. No. 4,098,370, described a vibration sound-masking system for delivering masking sound into a room or a building. This system generates vibrations on one part of the building structure with the aim of creating a masking sound. However, this system uses a standard diaphragm speaker to create the vibration of the structure with an acoustical wave.

A partition sound-masking system for open plan office spaces has been described by Horrall (see U.S. Pat. No. 4,476,572). Again, this system uses standard loudspeakers mounted in the partition. Another sound-masking system uses loudspeaker mounted in the desk furniture to generate the masking sound (see U.S. Pat. No. 4,761,921).

Recently, a personal sound-masking system has been proposed by Thomas R. Horrall, in U.S. Pat. No. 6,188,771. Here also, the proposed system uses standard loudspeakers.

More recently, flat panel technology has been used as a sound radiator on a sound-masking system (see U.S. Pat. No. 6,386,315 and U.S. Pat. No. 6,108,994, for example), the flat panel being especially designed to be installed on a ceiling grill to replace a ceiling panel.

### BRIEF DESCRIPTION OF THE DRAWINGS

In the appended drawings:

FIG. 1 illustrates positioning of a vibration exciter according to an embodiment of an aspect of the present invention;

FIG. 2 illustrates positioning of a vibration exciter according to a further embodiment of an aspect of the present invention;

FIG. 3 is a schematical view of a system according to an embodiment of an aspect of the present invention;

FIGS. 4 and 5 illustrate a vibration exciter usable in a system and method according to embodiments of aspects of the present invention;

FIG. 6 is a flowchart of a method according to an embodiment of another aspect of the present invention;

FIG. 7 illustrates positioning of a vibration exciter according to a further embodiment of an aspect of the present invention; and

FIG. 8 illustrates positioning of a vibration exciter according to a further embodiment of an aspect of the present invention.

### DESCRIPTION OF THE INVENTION

The present invention is illustrated in further details by the following non-limiting examples.

There is provided a method and a system for generating a masking sound using vibration exciter(s) fixed on pieces of furniture or structures of a room where the masking sound is to be generated.

A system according to an embodiment of an aspect of the present invention uses vibration exciters, which are directly fixed on a piece of furniture or another structure of a room, including, for example, desks, partitions, filing cabinets, etc. . . . to generate the masking sound, the piece of furniture or the structure of the room acting as sound radiator.

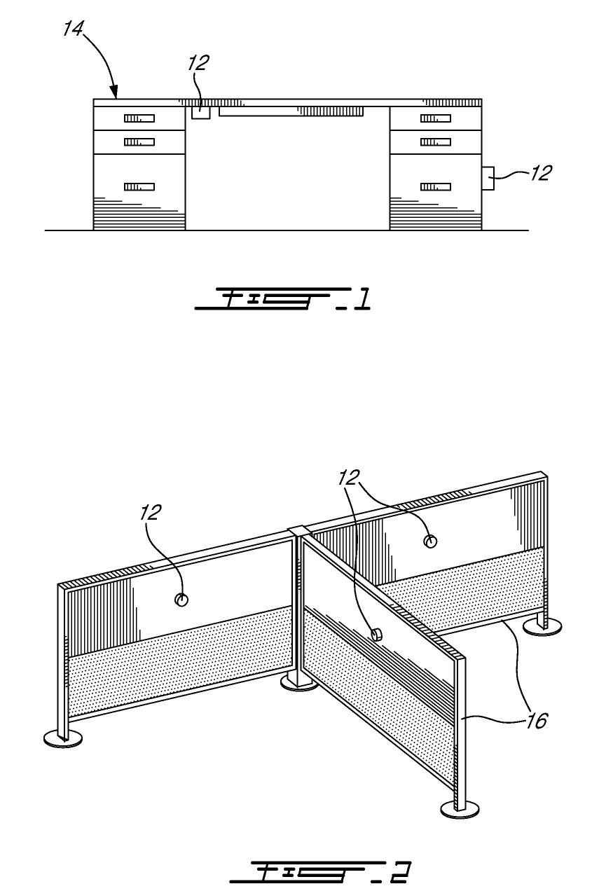

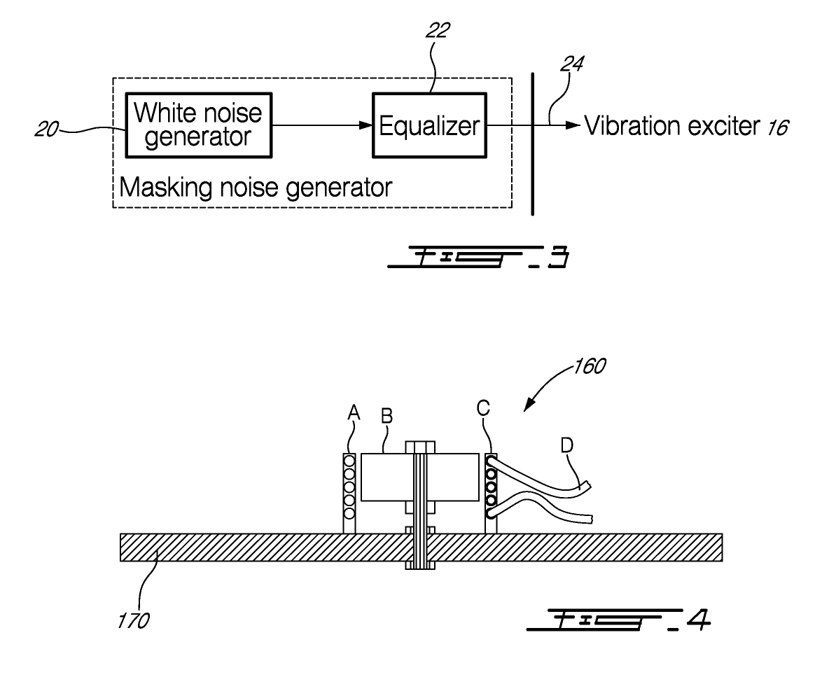

FIGS. 1 and 2 show vibration exciters 12 fixed on surfaces of a desk 14 and surfaces of open office partitions 16 respectively, for example.

In the present method and system, the pieces of furniture themselves (or other structures of the room) are used as acoustical radiators.

As illustrated in FIG. 3, the present system generally comprises a masking noise generator and a power amplifier 24 that drives at least one vibration exciter 12. The masking noise generator typically includes a white noise generator 20 and a signal equalizer 22, as will be discussed hereinbelow.

The vibration exciter 12 may be an electrodynamic vibration shaker, a piezoceramic actuator or any equipment capable of producing vibration for subjecting an existing structure of the room to control and reproducible mechanical vibrations.

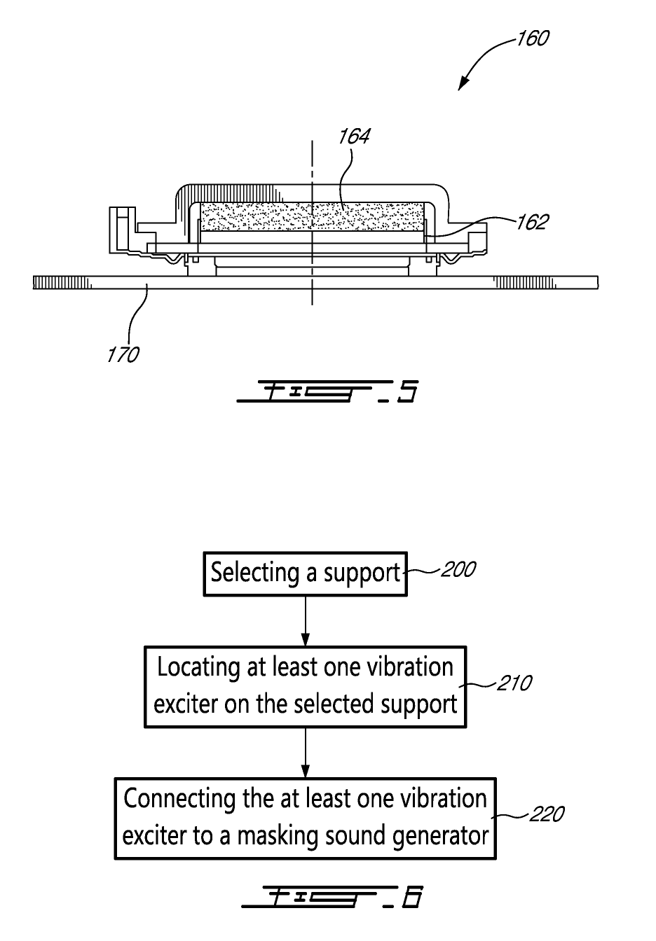

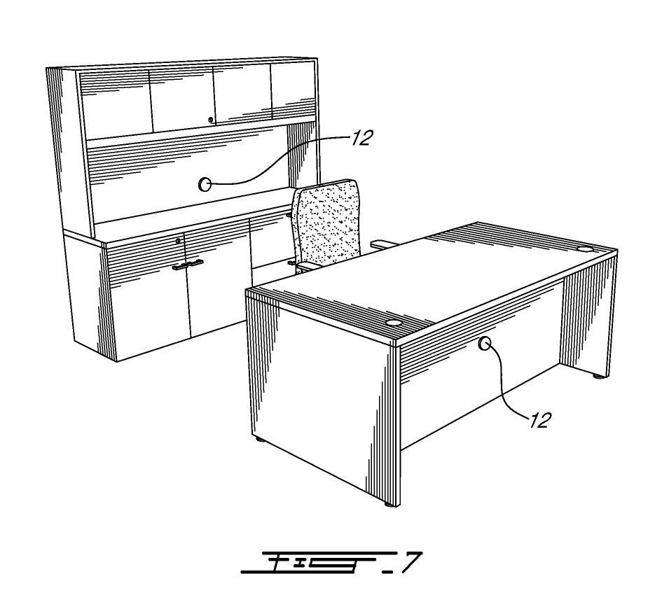

In FIGS. 4 and 5, for instance, a voice coil exciter type, such as the moving-coil exciter of NXT Company for example, is positioned on a surface. As known in the art, this moving coil exciter works through the interaction of two magnetic fields. A permanent magnet and associated metal components create a strong, static field which is concentrated in a narrow gap through which the voice coil is able to move. Signal current in the voice coil creates a weaker, fluctuating magnetic field which interacts with the static field to generate a force that faithfully follows the audio signal.

In FIG. 4, the exciter 160 positioned on surface 170 comprises coils A and C, magnet B, and electrical wires D connected to an electric source (not shown), including a sound-generator-equalizer-amplifier for example (not shown).

In FIG. 5, the moving coil exciter 160 on surface 170 comprises a coil 162 and a magnetic circuit. A permanent magnet 164 and associated metal components create a strong static field which is concentrated in a narrow gap through which the coil 162 is able to move.

The vibration exciter may be installed on gypsum wallboards walls, wood walls, removable partitions or open office panels for example, to generate sound in the area where the sound masking is required. The vibration exciter may also be installed on a modern access floor structure, also called raised floor, in order to generate the masking sound in the room.

The location of the vibration exciter on the piece of furniture or room structure is found to have an influence on the acoustic response and the acoustic radiation pattern of the vibrating structure formed by the piece of furniture or room structure. Depending on the shape of the piece or structure, its dimension, the type of materiel it is made of, for example, metal, glass, wood or other, assembly details and others physical parameters, as well as depending on the location of the vibration exciter on it, the sound generated by the piece or structure varies in amplitude at each frequency in each direction.

Typically, the vibration exciter may be fixed near the center of a flat surface of the piece of furniture or structure. However, if required and with a proper calibration process, the vibration exciter may be installed anywhere on the piece of furniture or structure in the room.

According to an embodiment of another aspect of the present invention, there is provided a method, comprising selecting a piece of furniture or a structure in a room for support; locating at least one vibration exciter on the selected support; and connecting the at least one vibration exciter to a masking noise generator and a power amplifier 24 (see FIG. 6).

Using a vibration exciter fixed on a piece of furniture or a structure allows benefiting from a large sound radiation surface, which result in a radiated sound that is quite diffuse and uniform in the area where the vibration exciter is installed. Depending on the support characteristics, including for example its dimension, geometry, material type, etc. . . . , two or more exciters may be used to obtain a more uniform masking sound field.

Since the acoustical response of any vibrating structure is specific, the source signal sent to the vibration exciter by the masking sound generator may have to be adjusted with a signal equalizer 22 or an equivalent device to obtain the desired sound-masking spectrum at a given location in the room, such as a worker station for example. Such a calibration process is also required for sound-masking systems using standard loudspeakers. Without being necessary, an automatic adjusting sound masking method, such as described for example in US patent application US2006/0009969 may be used to obtain the desired sound-masking spectrum.

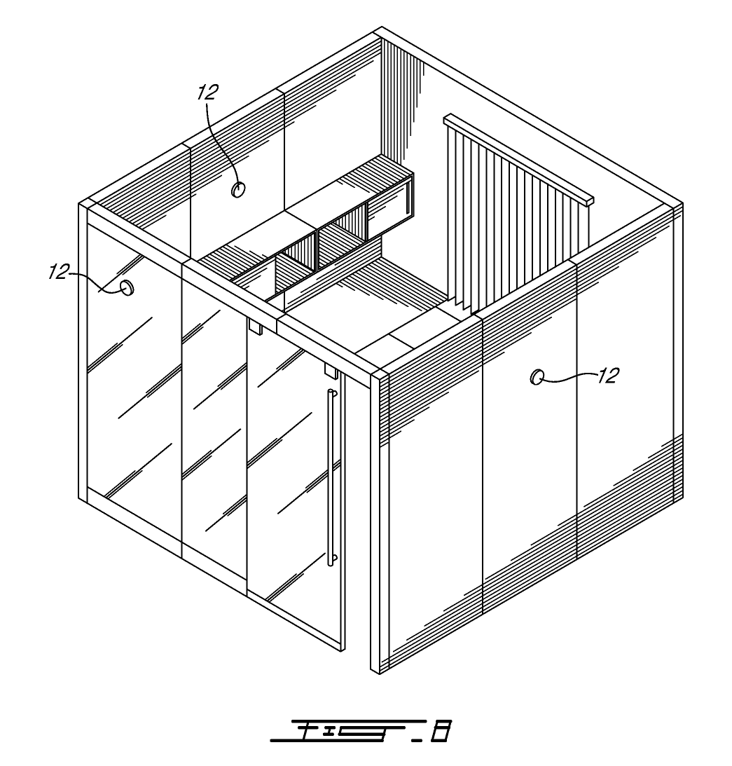

The vibration exciter(s) 12 may be directly included in the piece of furniture or the room structure during the manufacturing process of the piece of furniture or the room structure (desk, partition, wall and rise floor for example). In FIG. 7, vibration exciters 12 are embedded inside cavities especially provided in the piece of furniture. In FIG. 8, vibration exciters 12 are embedded in the thickness of removable walls or full height partitions. The signal generator 20, the equalizer 22 and the power amplifier 24 may also be included in the piece of furniture or the room structure, thereby providing a complete integrated solution for the sound masking.

Devices or integrated electronics including the signal generator, a preset equalization and/or a power amplifier may also be used, for integration in pieces of furniture such as desks, partitions, filing cabinets and any standard office furniture, for instance.

Therefore, the present method and system provide taking advantage of existing surfaces in a room where masking sound is required, by using them as radiating surfaces in combination with a source of excitation, thereby allowing eliminating the use of loud speakers.

Since existing surfaces are used as radiating surfaces, the frequency response, being a function of the modes of vibration of the corresponding structure/piece of furniture, which in turn depend on the dimensions, geometry, material etc. . . . of the corresponding structure/piece of furniture, may be irregular. Such frequency irregularities may be compensated by using an automatic adjusting sound masking method, such as described for example in US patent application US2006/0009969, or any standard manual adjustment technique as known in the art, to obtain a desired uniform sound-masking spectrum.

By substituting vibration exciters for loudspeakers in sound masking systems and methods, the present invention allows cost savings since vibration exciters are cheaper.

Moreover, the present invention allows furniture manufacturers, such as office furniture manufacturers for example, to provide furniture including an integrated sound-masking system.

Although the present invention has been described hereinabove by way of specific embodiments thereof, it can be modified, without departing from the nature and teachings of the subject invention as described herein.

1. A system for generating a sound masking in a room, comprising:
a masking sound generator; and
at least one vibration exciter connected to a support in the room;
wherein said masking sound generator sends a source signal to the at least one vibration exciter and said at least one vibration exciter subjects said support of the room to controlled and reproducible mechanical vibrations, said support acting as a sound radiator.

2. The system of claim 1, wherein said masking sound generator comprises a white noise signal generator.

3. The system of claim 1, wherein said masking sound generator comprises a white noise signal generator and a signal equalizer.

4. The system of claim 1, further comprising a power amplifier between said masking sound generator and said at least one vibration exciter.

5. The system of claim 1, further comprising a calibration unit, said calibration unit adjusting the source signal sent from the masking sound generator to said at least one vibration exciter.

6. The system of claim 1, wherein said at least one vibration exciter is one of: a standard electrodynamics shaker; a piezoceramic actuator; and a voice coil exciter.

7. The system of claim 1, wherein said support is one of: a piece furniture of the room and a structure in the room.

8. The system of claim 1, wherein said support is one of a desk, a partition, a wallboard, a removable wall, a cabinet, a raised floor of the room.

9. The system of claim 1, wherein at least one of i) said sound generator and ii) said at least one vibration exciter is incorporated in said support.

10. A method for generating a masking sound in a room, comprising:
selecting a pre-existing support in the room;
locating at least one vibration exciter on the selected pre-existing support; and
connecting the at least one vibration exciter to a masking sound generator;
whereby, when receiving a source signal from the masking sound generator, the at least one vibration exciter subjects the selected pre-existing support of the room to controlled and reproducible mechanical vibrations.

11. The method of claim 10, further comprising adjusting the source signal generated by the noise signal generator according to an acoustical response of the vibrating pre-existing support.

12. A method for generating a sound masking in a room, comprising using a masking sound generator, a pre-existing support in the room as a radiating surface in combination with a source of excitation, the source of excitation, activated by the masking sound generator, subjecting the pre-existing support to controlled and reproducible mechanical vibrations.
